(19) United States
(12) Patent Application Publication
(10) Pub. No.: US 2015/0121468 A1
(43) Pub. Date: Apr. 30, 2015

(54) PHYSICAL LAYER SECURITY METHOD IN WIRELESS LAN AND WIRELESS COMMUNICATION SYSTEM USING THE SAME

(71) Applicants: Gun Byum Park, Suwon-si Gyeonggi-do (KR); Gwan Hee Han, Suwon-si Gyeonggi-do (KR); Kyoung Soo Kim, Bucheon-si Gyeonggi-do (KR)

(72) Inventors: Gun Byum Park, Suwon-si Gyeonggi-do (KR); Gwan Hee Han, Suwon-si Gyeonggi-do (KR); Kyoung Soo Kim, Bucheon-si Gyeonggi-do (KR)

(73) Assignees: LS CABLE LTD., Anyang-si Gyeonggi-do (KR); GLOSCOM CO., LTD., Seoul (KR)

(21) Appl. No.: 14/399,564

(22) PCT Filed: Sep. 13, 2012
(86) PCT No.: PCT/KR2012/007334

§ 371 Date: Nov. 7, 2014

(30) Foreign Application Priority Data
May 8, 2012 (KR) 10-2012-0048361

(51) Int. Cl. H04W 12/08; H04W 48/02

(52) U.S. Cl. CPC H04W 12/08; H04W 48/02; H04W 84/12
USPC 726/4

(57) ABSTRACT

A security method in a physical layer and a wireless communication system using the same are provided. A wireless communication Access Point (AP) whose security has been enhanced in the physical layer includes a storage unit that manages channel bandwidth pattern data, a controller for sequentially acquiring channel bandwidth data from the channel bandwidth pattern data, a PLL controller for changing a channel bandwidth based on the acquired channel bandwidth data, and a wireless interface unit for performing wireless communication with a wireless communication terminal using the changed channel bandwidth. The channel bandwidth pattern data is identical to channel bandwidth pattern data stored in the wireless communication terminal, and the wireless communication terminal and the wireless communication AP are synchronized with each other such that the wireless communication terminal and the wireless communication AP perform wireless communication using the same channel bandwidth.

### TECHNICAL FIELD

The present invention relates to a physical layer security method in a wireless LAN and a wireless communication system using the same.

### BACKGROUND ART

A wireless Local Area Network (LAN) is a LAN in which two or more computers are connected to each other wirelessly rather than by wire. The wireless LAN allows devices in a limited area to perform communication with each other using OFDM modulation technology.

The wireless LAN has an advantage in that it does not need cables for communication. Wireless LAN environments have rapidly grown replacing conventional wired LAN environments due to an increase in the number of users of mobile devices such as laptops, smartphones, and tablets.

However, since the wireless LAN provides a network to communication devices using radio frequencies, the wireless LAN has a disadvantage in that it is vulnerable to communication interference or in terms of security compared to the wired LAN which uses physical cables as communication means.

The conventional wireless LAN uses various security methods for access control of communication terminals. In one method, an authorized user terminal and an access point have the same shared key and the access point performs user authentication using the shared key upon receiving an access request from the user terminal. In another method, a Medium Access Control (MAC) address of an licensed user terminal is previously input to the access point and, when the access point receives an access request from a user terminal, the access point compares a MAC address of the user terminal with the stored MAC address to perform user authentication. Another method is an IEEE 802.1x authentication method in which a user accesses a RADIUS server through a wireless Network using authentication information of the user to perform an authentication procedure.

Such conventional wireless LAN based security methods are performed in network layers 2 to 7 among the communication layers and typical examples thereof include Wired Equivalent Privacy (WEP), Wi-Fi Protected Access (WPA), and WPA2.

However, such conventional security methods which perform authentication, authorization, or account management in network layers 2 to 7 have a problem in that a malicious user may gather data on the air to extract a WEP key.

In addition, the conventional security method which performs user authentication using an input MAC address of a wireless LAN card has a problem in that it is nearly impossible to perform management when a public network service is provided to a number of unspecified users or when a lot of users are present. In addition, unidirectional IEEE 802.1x authentication based on Extensible Authentication Protocol Message Digest 5 (EAP-MD5) is vulnerable to brute force attacks and the WEP algorithm also has any limitation.

Accordingly, there is a need to introduce technology that can perform wireless LAN security in layer 1 which replaces the conventional security, layers 2 to 7 security.

### DISCLOSURE OF INVENTION

### Technical Problem

Therefore, the present invention has been made in view of the above problems, and it is an object of the present invention to provide a wireless communication security method in which a wireless communication Access Point (AP) and a wireless communication terminal perform communication with each other using a variable channel bandwidth in a wireless LAN such that it is possible to block access by an unauthorized communication terminal which does not share the variable channel bandwidth.

The present invention is not limited to the above objects and other objects not described above will be clearly understood from the following description.

### Solution to Problem

In accordance with an aspect of the present invention, the above and the other objects can be accomplished by the provision of a wireless communication Access Point (AP) whose security has been enhanced in a physical layer, the wireless communication AP comprising a storage unit that manages channel bandwidth pattern data; a controller for sequentially acquiring channel bandwidth data from the channel bandwidth pattern data; a PLL controller for changing a channel bandwidth based on the acquired channel bandwidth data; and a wireless interface unit for performing wireless communication with a wireless communication terminal using the changed channel bandwidth,

wherein the channel bandwidth pattern data is identical to channel bandwidth pattern data stored in the wireless communication terminal, and the wireless communication terminal and the wireless communication AP are synchronized with each other such that the wireless communication terminal and the wireless communication AP perform wireless communication using the same channel bandwidth.

The channel bandwidth pattern data is a series of pattern data including one or more channel bandwidth data, each having a unique value or some values.

The channel bandwidth pattern data further includes a channel bandwidth change period data that corresponds to the channel bandwidth data.

The storage unit includes a pattern table in which a plurality of channel bandwidth pattern data is stored, and the controller acquires channel bandwidth pattern data, which corresponds to a key value input by a user, from the pattern table based on the input key value.

The wireless communication AP further comprising a user interface that receives at least one of channel bandwidth data or a channel bandwidth change instruction from a user, and the controller changes the channel bandwidth based on the received channel bandwidth data in response to input of the channel bandwidth change instruction.

The channel bandwidth pattern data is a series of pattern data including one or more channel bandwidth data, each having a unique value or some values.

The channel bandwidth pattern data further includes a channel bandwidth change period data that corresponds to the channel bandwidth data.

The storage unit includes a pattern table in which a plurality of channel bandwidth pattern data is stored, and the controller acquires channel bandwidth pattern data, which corresponds to a key value input by a user, from the pattern table based on the input key value.

The wireless communication AP further comprising a user interface that receives at least one of channel bandwidth data or a channel bandwidth change instruction from a user, and the controller changes the channel bandwidth based on the received channel bandwidth data in response to input of the channel bandwidth change instruction.

The controller transmits a channel bandwidth change notification signal to the wireless communication terminal through the wireless interface unit and changes the channel bandwidth upon receiving a channel bandwidth change response signal from the wireless communication terminal within a predetermined time in response to the channel bandwidth change notification signal.

And in accordance with an aspect of the present invention, the above and other objects can be accomplished by the provision of a wireless communication terminal whose security has been enhanced in a physical layer, the wireless communication terminal comprising a storage unit that manages channel bandwidth pattern data; a controller for sequentially acquiring channel bandwidth data from the channel bandwidth pattern data; a PLL controller for changing a channel bandwidth based on the acquired channel bandwidth data; and a wireless interface unit for performing wireless communication with a wireless communication Access Point (AP) using the changed channel bandwidth, wherein the channel bandwidth pattern data is identical to channel bandwidth pattern data stored in the wireless communication AP, and the wireless communication AP and the wireless communication terminal are synchronized with each other such that the wireless communication AP and the wireless communication terminal perform wireless communication using the same channel bandwidth.

The channel bandwidth pattern data is a series of pattern data including one or more channel bandwidth data, each having a unique value or some values.

The channel bandwidth pattern data further includes a channel bandwidth change period T1 value that corresponds to the value of channel bandwidth data.

The PLL controller receives channel bandwidth data from the controller and changes channel bandwidths at intervals of a channel bandwidth search period T2, and the controller determines whether or not a channel bandwidth of the wireless communication AP is identical to any of the channel bandwidths changed at intervals of the channel bandwidth search period T2 and achieves synchronization with a changed channel bandwidth identical to the channel bandwidth of the wireless communication AP.

The channel bandwidth search period T2 is set to be smaller than the channel bandwidth change period T1.

The storage unit includes a pattern table in which a plurality of channel bandwidth pattern data is stored, and the controller acquires channel bandwidth pattern data, which corresponds to a key value input by a user, from the pattern table based on the input key value.

The controller transmits a channel bandwidth change response signal to the wireless communication AP within a predetermined time in response to a channel bandwidth change notification signal received from the wireless communication AP.

And in accordance with an aspect of the present invention, the above and other objects can be accomplished by the provision of a wireless communication system whose security has been enhanced in a physical layer, the wireless communication system comprising a wireless communication Access Point (AP) that sequentially changes channel bandwidths according to predefined channel bandwidth pattern data; and a wireless communication terminal that sequentially changes channel bandwidths according to channel bandwidth pattern data identical to the channel bandwidth pattern data of the wireless communication AP and performs wireless communication with the wireless communication AP,

wherein the wireless communication AP and the wireless communication terminal change channel bandwidths based on the channel bandwidth pattern data through PLL control, and the wireless communication AP and the wireless communication terminal are synchronized with each other such that the wireless communication AP and the wireless communication terminal perform wireless communication using the same channel bandwidth.

The channel bandwidth pattern data is a series of pattern data including one or more channel bandwidth data, each having a unique value or some values.

The channel bandwidth pattern data further includes a channel bandwidth change period T1 that corresponds to the value of channel bandwidth data.

The wireless communication AP sequentially changes channel bandwidths at intervals of the channel bandwidth change period T1, and the wireless communication terminal sequentially changes channel bandwidths based on the channel bandwidth pattern data at intervals of a channel bandwidth search period T2, searches for a channel bandwidth that matches a channel bandwidth of the wireless communication AP, and changes a channel bandwidth of the wireless communication terminal to the matching channel bandwidth.

The channel bandwidth search period T2 is set to be smaller than the channel bandwidth change period T1.

Each of the wireless communication AP and the wireless communication terminal manages a pattern table in which a plurality of channel bandwidth pattern data is stored, and the wireless communication AP or the wireless communication terminal acquires channel bandwidth pattern data that corresponds to a key value input by a user based on the input key value.

The wireless communication AP transmits a channel bandwidth change notification signal to the wireless communication terminal, the wireless communication terminal transmits a channel bandwidth change response signal to the wireless communication AP within a predetermined time in response to the channel bandwidth change notification signal, and the wireless communication AP changes a channel bandwidth of the wireless communication AP upon receiving the channel bandwidth change response signal from the wireless communication terminal within a predetermined time.

And in accordance with an aspect of the present invention, the above and other objects can be accomplished by the provision of a method for providing security in a wireless communication system through variable channel bandwidth control, the method comprising a wireless communication Access Point (AP) sequentially acquiring channel bandwidth data from channel bandwidth pattern data; the wireless communication AP changing a channel bandwidth based on the acquired channel bandwidth data; the wireless communication AP performing channel bandwidth synchronization with a wireless communication terminal; and the wireless communication AP performing wireless communication with the wireless communication terminal.

Performing the channel bandwidth synchronization includes changing the channel bandwidth at intervals of a channel bandwidth search period T2; determining whether or not the changed channel bandwidth is identical to a channel bandwidth of the wireless communication AP; acquiring next channel bandwidth data from the channel bandwidth pattern data when the changed channel bandwidth is not identical to the channel bandwidth of the wireless communication AP; and changing the channel bandwidth based on the next channel bandwidth data.

Sequentially extracting the channel bandwidth data further includes the wireless communication AP acquiring a channel bandwidth change period T1, which is stored so as to correspond to the channel bandwidth data, from the channel bandwidth pattern data.

Changing the channel bandwidth includes the wireless communication AP changing the channel bandwidth using the extracted channel bandwidth data; acquiring next channel bandwidth data from the channel bandwidth pattern data after the channel bandwidth change period T1 elapses; and changing the channel bandwidth based on the next channel bandwidth data.

The wireless communication AP further includes a pattern table including one or more channel bandwidth pattern data, and the method further comprising the wireless communication AP selecting, pattern data which corresponds to a key value input by a user, from the pattern table before sequentially extracting the channel bandwidth data.

And in accordance with an aspect of the present invention, the above and other objects can be accomplished by the provision of a method for providing security in a wireless communication system through variable channel bandwidth control, the method comprising a wireless communication Access Point (AP) detecting a channel bandwidth change signal input by a user; the wireless communication AP transmitting a channel bandwidth change notification signal to a wireless communication terminal; the wireless communication AP receiving a channel bandwidth change response signal from the wireless communication terminal in response to the channel bandwidth change notification signal; the wireless communication AP changing a channel bandwidth; and the wireless communication AP performs wireless communication with the wireless communication terminal.

The method further comprising the wireless communication AP repeatedly transmitting the channel bandwidth change notification signal a preset number of times when the channel bandwidth change response signal has not been received within a preset time before changing the channel bandwidth.

Changing the channel bandwidth includes changing the channel bandwidth using a channel bandwidth data input by the user.

Changing the channel bandwidth includes the wireless communication AP acquiring a channel bandwidth data from channel bandwidth pattern data; and changing the channel bandwidth based on the acquired channel bandwidth data.

The wireless communication AP further includes a pattern table including one or more channel bandwidth pattern data, the method further comprising the wireless communication AP selecting, a pattern data which corresponds to a key value input by the user, from the pattern table before detecting the channel bandwidth change signal.

### Advantageous Effects of Invention

According to one of the means for solving the present invention, a wireless communication AP and a wireless communication terminal perform communication with each other using a changed channel bandwidth in a wireless LAN such that it is possible to block access by an unauthorized communication terminal which does not share the changed channel bandwidth.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates frequencies and bandwidths used for conventional wireless LAN;

FIG. 2 is an overall schematic diagram illustrating a wireless communication system according to an embodiment of the present invention;

FIG. 3 illustrates communication layers;

FIG. 4 is a block diagram illustrating a detailed configuration of a wireless communication AP according to an embodiment of the present invention;

FIG. 5 is a block diagram illustrating a detailed configuration of a wireless communication terminal according to an embodiment of the present invention;

FIG. 6 is a block diagram illustrating a detailed configuration of a PLL controller which is one component included in the wireless communication AP of FIG. 4 and the wireless communication terminal of FIG. 5;

FIG. 7 is a flowchart illustrating a first embodiment of a physical layer security method in the wireless communication system of the present invention;

FIG. 8 is a flowchart illustrating a second embodiment of a physical layer security method in the wireless communication system of the present invention;

FIG. 9 is a flowchart illustrating a third embodiment of a physical layer security method in the wireless communication system of the present invention;

FIG. 10 is a flowchart illustrating a fourth embodiment of a physical layer security method in the wireless communication system of the present invention; and

FIG. 11 is a flowchart illustrating a fifth embodiment of a physical layer security method in the wireless communication system of the present invention.

### BEST MODE FOR CARRYING OUT THE INVENTION

The present invention may be modified in various ways and provide various embodiments. The present invention will be described below through a detailed description of specific embodiments illustrated in the accompanying drawings. The detailed description is not intended to limit the present invention and it should be understood that the present invention includes all changes, equivalents, or substitutions within the spirit and scope of the present invention.

In the following description of the present disclosure, a detailed description of known related technologies will be omitted when it may obscure the subject matter of the present disclosure. Numbers or ordinals (for example, first and second) that are used in the description of this specification are merely reference symbols for discriminating between components.

When it is stated that one component is “connected” or “coupled” to another component, it is to be understood that the two components may not only be directly “connected” or “coupled” but may also be indirectly “connected” or “coupled” via another component unless specifically stated otherwise.

The term “wireless communication AP” in this specification refers to a wireless communication hub or a base station that transmits or receives wireless traffic such as Wi-Fi data and “wireless communication terminal” refers to a device that transmits or receives wireless traffic such as Wi-Fi data to or from a wireless communication AP or other wireless communication terminals, which may be a mobile terminal such as a mobile phone, a smart phone, a notebook, a digital broadcast terminal, a Personal Digital Assistant (PDA), a Portable Multimedia Player (PMP), or a navigation device or may be a household appliance such as a wall mountable TV, a digital photo frame, or a refrigerator which includes a wireless communication module.

A detailed description of embodiments for practicing the present invention will now be given with reference to the accompanying drawings.

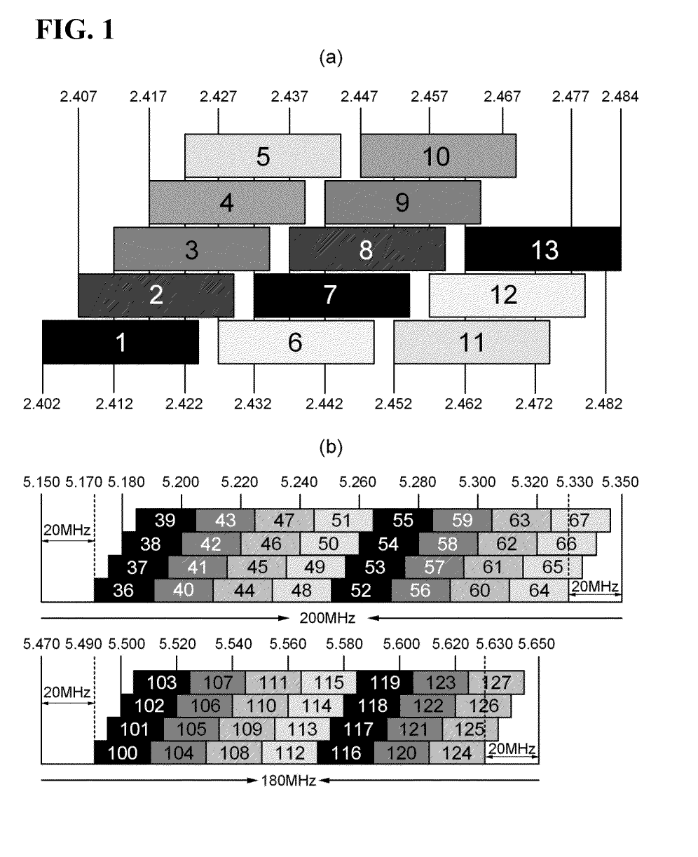

FIG. 1 illustrates frequencies and bandwidths used for conventional wireless LAN.

Conventional wireless LAN communication uses communication channels and bandwidths which are previously specified for communication between terminals or communication between a terminal and an AP. Here, communication between terminals is also referred to as ad-hoc or peer-to-peer communication.

Generally, wireless LAN standards for wireless LAN communication are defined in IEEE 802.11. IEEE 802.11b (11b) and IEEE 802.11g (11g) define a standard which uses frequencies of a 2.4 GHz band as shown in FIG. 1(a) and IEEE 802.11a (11a) define a standard which uses frequencies of a 5 GHz band as shown in FIG. 1(b).

As shown in FIG. 1(a), the 2.4 GHz IEEE 802.11b/g standards define a total of 13 channels which are arranged at intervals of 5 MHz in a range of 2.412 GHz to 2.472 GHz. In this case, since the channel bandwidth of 11b is 22 GHz, radio interference is caused by bandwidth overlapping between adjacent channels and therefore the number of channels that can be simultaneously used is about 3. For example, it is preferable that channels 1, 6, and 11 be used such that the channels do not overlap.

In FIG. 1(b), the 5 GHz IEEE 802.11a standard defines a total of 200 channels into which frequencies of a band of 5 to 6 GHz is divided at intervals of 5 MHz. In this case, the channel bandwidth of 11a is 20 GHz.

As described above, wireless LAN according to the IEEE 802.11 standards perform wireless communication using channels and bandwidths which are predefined between terminals or between a terminal and an AP.

A wireless LAN system of the present invention changes the channel bandwidth to tighten security of the physical layer, thereby blocking connection of an unauthorized wireless communication terminal to the wireless LAN.

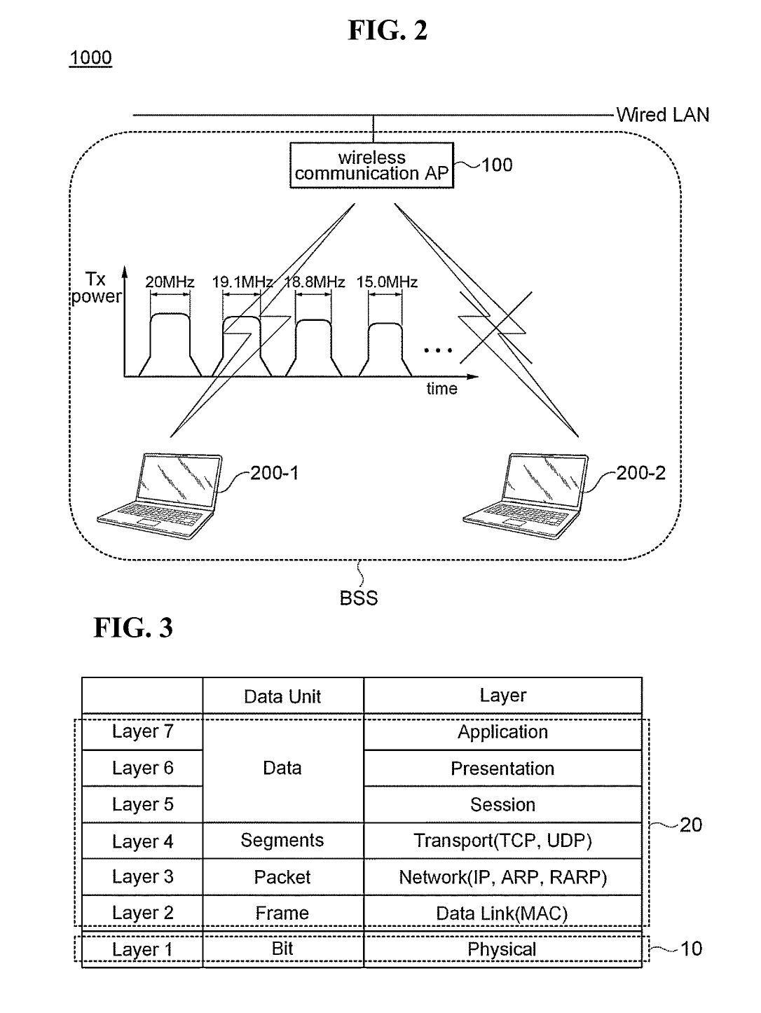

FIG. 2 is an overall schematic diagram illustrating a wireless communication system according to an embodiment of the present invention. In a wireless communication system 1000 of the present invention, wireless communication is performed between a wireless communication AP 100 and a wireless communication terminal 200 using the same channel and the same channel bandwidth. Here, the bandwidth of the communication channel used for wireless communication is changed according to a change instruction from a manager and channel bandwidth change states of the wireless communication AP 100 and the wireless communication terminal 200 are synchronized through a synchronization procedure.

For example, in the example of FIG. 2, the wireless communication AP 100 and a wireless communication terminal 200-1 may sequentially change the channel bandwidth in the order of 20 MHz->19.1 MHz->18.8 MHz->15.0 MHz and such channel bandwidth changes of the wireless communication AP 100 and the wireless communication terminal 200-1 may be synchronized through a synchronization procedure. On the other hand, a wireless communication terminal 200-2 to which the security method of the present invention is not applied uses a channel bandwidth (for example, 20 MHz) of the standard for wireless communication. Therefore, even though the wireless communication terminal 200-2 belongs to the range of a Basic Service Set (BSS) configured by the wireless communication AP 100, wireless communication is not performed between the wireless communication AP 100 which uses a variable channel bandwidth and the wireless communication terminal 200-2 which uses the standard channel bandwidth.

As shown in FIG. 3, according to the conventional wireless communication security method, transmitted and received data is mostly encoded and decoded by applying the security method to layers 2 to 7 (20) among the seven layers 1 to 7 which constitute the communication network. On the other hand, the wireless communication system 1000 of the present invention operates in layer 1 (10) which is the physical layer and therefore it is possible to prevent malicious user equipment from illegally gathering data on the air.

Detailed configurations of the wireless communication AP 100 and the wireless communication terminal 200 included in the wireless communication system according to an embodiment of the present invention are described below in detail.

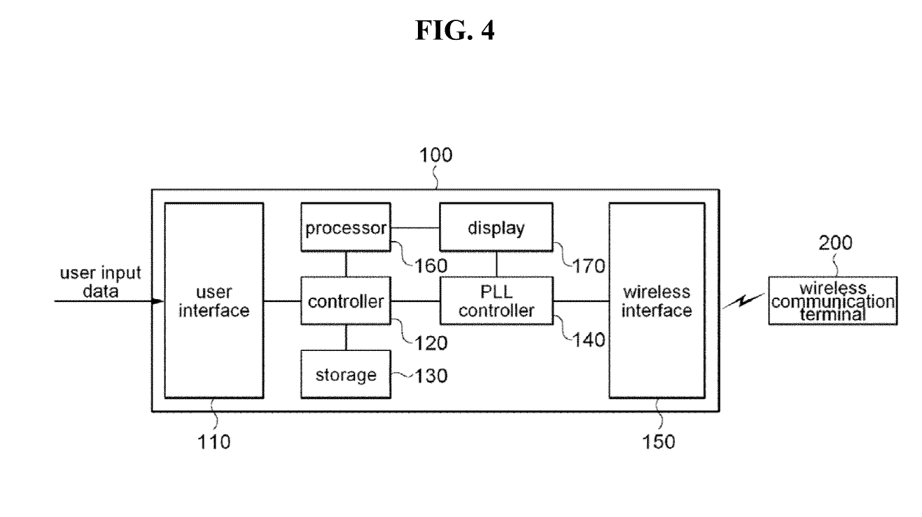

FIG. 4 is a block diagram illustrating a detailed configuration of a wireless communication AP according to an embodiment of the present invention.

As shown in FIG. 4, a wireless communication AP 100 includes a user interface 110, a controller 120, a storage unit 130, a PLL controller 140, and a wireless interface 150.

The user interface 110 serves to process data input by a user. For example, the user interface 110 may be one or more input buttons which are externally provided on the wireless communication AP 100, a touch screen which is combined with the display unit 170 to detect user touch input, or a communication port for connecting an external input device such as a keyboard or a mouse.

The user may instruct the wireless communication AP 100 to change the channel bandwidth through the user interface 110 and may also directly input a channel bandwidth, which the user desires to apply, through the user interface 110.

The controller 120 may control the PLL controller 140, which will be described in detail later, to switch to a desired channel bandwidth.

When power is applied to the wireless communication AP 100 or when the controller 120 has received a channel bandwidth change instruction from the user, the controller 120 reads channel bandwidth data from channel bandwidth pattern data stored in the storage unit 130 and provides the read channel bandwidth data to the PLL controller 140 to change a corresponding communication channel bandwidth.

The controller 120 performs channel bandwidth synchronization through communication with the wireless communication terminal 200. Channel bandwidth synchronization is performed when a new wireless communication terminal 200 is connected to the wireless communication AP 100 while the wireless communication AP 100 is running and is a procedure for determining the position of the same channel bandwidth data as the current channel bandwidth of the wireless communication AP 100 in the channel bandwidth pattern data and achieving channel bandwidth synchronization with the wireless communication AP 100. Details of the channel bandwidth synchronization procedure are described later.

The controller 120 changes the channel bandwidth upon receiving a channel bandwidth change instruction from the user. Specifically, upon receiving a channel bandwidth change instruction from the user or manager, the controller 120 transmits a channel bandwidth change notification signal to the wireless communication terminal 200. The controller 120 changes the channel bandwidth upon receiving a channel bandwidth change request signal from the wireless communication terminal 200 in response to the channel bandwidth change notification signal. Here, the wireless communication terminal 200 changes the channel bandwidth to the same channel bandwidth.

The storage unit 130 stores and manages channel bandwidth pattern data. The channel bandwidth pattern data is a list of channel bandwidth data stored in order for setting communication channel bandwidths between the wireless communication AP 100 and the wireless communication terminal 200.

The channel bandwidth pattern data may additionally include data for setting a channel bandwidth change period. The channel bandwidth change period data may be applied only to a specific channel bandwidth data or may be applied to all channel bandwidth data in the channel bandwidth pattern data.

Each channel bandwidth data in the channel bandwidth pattern data may be set to a unique value or some values so as not to overlap each other in the channel bandwidth pattern data. In this case, it is possible to easily perform channel bandwidth synchronization of the wireless communication terminal 200 by retrieving the same channel bandwidth data as the currently operating channel bandwidth data of the wireless communication AP 100 from the channel bandwidth pattern data.

The storage unit 130 may store and manage one or more channel bandwidth pattern data items in a pattern table. In this case, each channel bandwidth pattern data item may be indexed through a unique key value and the controller 120 may acquire a specific channel bandwidth pattern data item from the pattern table using the unique key value. In this case, each channel bandwidth data stored in the pattern table may be set to a unique value or some values.

The PLL controller 140 may change the bandwidth of a selected channel based on the channel bandwidth data received from the controller 120. To accomplish this, the PLL controller 140 changes the bandwidth through Phase Locked Loop (PLL) control.

A detailed configuration and operation of the PLL controller 140 are described as follows with reference to FIG. 6. First, the PLL controller 140 includes a phase comparator (comparison circuit) 142, a pulse-voltage conversion circuit 144, and a voltage controlled oscillator 146. The comparison circuit 142 compares an input signal 141 with a fed-back output signal 148 of the voltage controlled oscillator 146 to calculate a phase difference between the input signal 141 and the fed-back output signal 148. The phase difference detected by the comparison circuit 142 is converted into a DC voltage through the pulse-voltage conversion circuit (low pass filter) 144. The converted DC voltage is input to the voltage controlled oscillator 146. The voltage controlled oscillator 146 changes the capacitance of a varactor to change the oscillating frequency of an LC resonance circuit, thereby generating an output frequency fixed to the phase of the input reference frequency. Here, it is possible to generate an output signal 149 with a changed bandwidth by controlling a received PLL clock.

Through such an operation of the PLL controller 140, the bandwidth of the selected channel of the wireless communication AP 100 may be changed at intervals of a predetermined unit, for example, may be arbitrarily changed at intervals of 1 KHz between 5 MHz and 40 MHz.

The configuration of the PLL controller 140 shown in FIG. 6 may be similar to that of the PLL controller 220 included in the wireless communication terminal 200 included in the wireless communication system 1000 of the present invention.

The wireless interface 150 performs wireless communication with the wireless communication terminal 200 using the changed channel bandwidth. The wireless interface 150 may also be used to perform communication with the wireless communication terminal 200 in a channel bandwidth synchronization procedure between the wireless communication AP 100 and the wireless communication terminal 200.

The wireless communication AP 100 may further include a processor 160 for controlling components other than those described above and a display unit 170 for displaying information such as setting values or the operating state of the wireless communication AP 100.

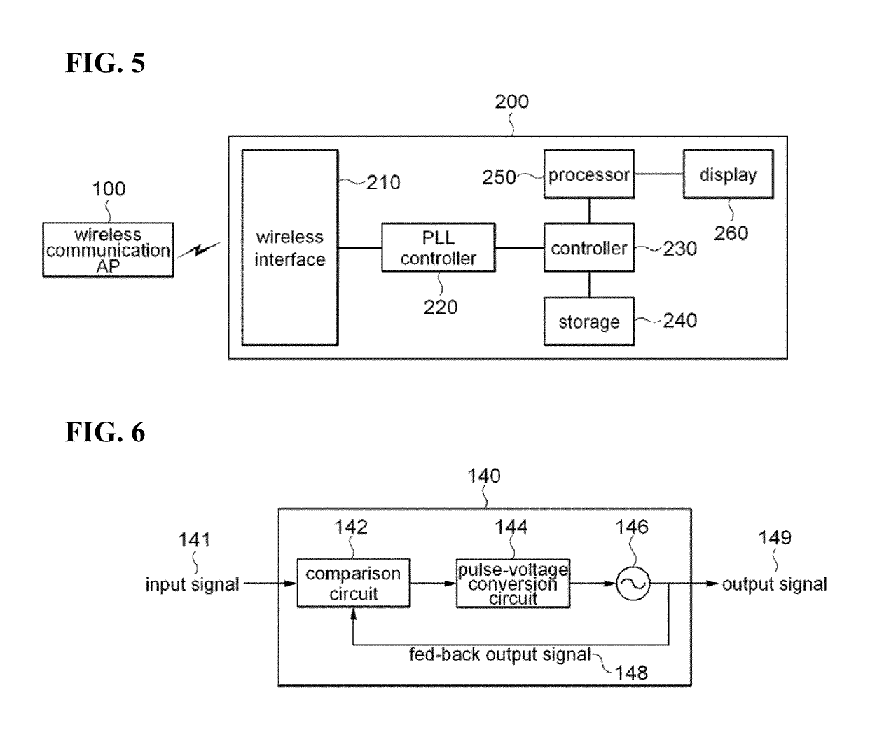

FIG. 5 is a block diagram illustrating a detailed configuration of a wireless communication terminal according to an embodiment of the present invention.

As shown in FIG. 5, the wireless communication terminal 200 of the present invention includes a wireless interface 210, a PLL controller 220, a controller 230, and a storage unit 240.

The wireless interface 210 performs wireless communication with the wireless communication AP 100 using a changed channel bandwidth. The wireless interface 210 may also be used to perform communication with the wireless communication AP 100 in a channel bandwidth synchronization procedure between the wireless communication AP 100 and the wireless communication terminal 200.

The PLL controller 220 changes the bandwidth of a selected channel based on channel bandwidth data received from the controller 230. To accomplish this, the PLL controller 220 changes the channel bandwidth through PLL control. The PLL control procedure of the PLL controller 220 is similar to the control procedure of the PLL controller 140 of the wireless communication AP 100 which is described above with reference to FIG. 6 and therefore a redundant description thereof is omitted herein.

The controller 230 sequentially acquires channel bandwidth data from channel bandwidth pattern data and provides the acquired channel bandwidth data to the PLL controller 220 such that it is possible to arbitrarily change the bandwidth of the communication channel.

Specifically, when the wireless communication terminal 200 starts wireless communication, the controller 230 sequentially reads a list of channel bandwidth data from channel bandwidth pattern data stored in the storage unit 240 and provides each read channel bandwidth data to the PLL controller 220 to change the bandwidth of the communication channel.

The controller 230 performs communication with the wireless communication AP 100 through the wireless interface 210 to perform channel bandwidth synchronization with the wireless communication AP 100.

For example, when a change period indicated by channel bandwidth change period data included in the channel bandwidth pattern data is T1, the wireless communication AP 100 changes the channel bandwidth at intervals of T1.

The channel bandwidth synchronization procedure is performed when the wireless communication terminal 200 is initially connected to the wireless communication AP 100 or when channel bandwidth synchronization is broken while performing wireless communication with the wireless communication AP 100.

The channel bandwidth synchronization procedure is a procedure for the wireless communication terminal 200 to acquire current channel bandwidth information of the wireless communication AP 100. To accomplish this, the wireless communication terminal 200 checks whether or not it is possible to perform communication with the wireless communication AP 100 while rapidly changing the channel bandwidth by applying each channel bandwidth data included in the stored channel bandwidth pattern data at specific intervals.

Here, when the application time of each channel bandwidth is referred to as a “channel bandwidth search period T2” and a period of time in which the wireless communication AP 100 changes the currently set channel bandwidth to another value is referred to as a “channel bandwidth change period T1”, the wireless communication terminal 200 needs to check matching of as many channel bandwidth values as possible within the channel bandwidth change period T1. Accordingly, the channel bandwidth search period T2 needs to be significantly smaller than the channel bandwidth change period T1. For example, it is preferable that the channel bandwidth search period T2 be set to be smaller than the channel bandwidth change period divided by n (i.e., T2<T1/n) when n channel bandwidth data are included in one channel bandwidth pattern data.

The wireless communication terminal 200 which has not normally completed such a channel bandwidth synchronization procedure is very less likely to operate simultaneously with the wireless communication AP 100 with the same channel bandwidth as that of the wireless communication AP 100. Therefore, it is possible to block unauthorized wireless communication by a terminal which has not been subjected to a normal channel bandwidth synchronization procedure.

The storage unit 240 stores and manages channel bandwidth pattern data. The wireless communication terminal 200 may share the same channel bandwidth pattern data as that of the wireless communication AP 100 for wireless communication with the wireless communication AP 100.

The channel bandwidth pattern data may additionally include data for setting a channel bandwidth change period. The channel bandwidth change period data may be applied only to a specific channel bandwidth data or may be applied to all channel bandwidth data in the channel bandwidth pattern data.

Each channel bandwidth data in the channel bandwidth pattern data may be set to a unique value or some values so as not to overlap each other in the channel bandwidth pattern data.

The storage unit 240 may store and manage one or more channel bandwidth pattern data items in a pattern table. In this case, each channel bandwidth pattern data item may be indexed through a unique key value and the controller 230 may acquire a specific channel bandwidth pattern data from the pattern table using the unique key value. In this case, each channel bandwidth data stored in the pattern table may be set to a unique value or some values.

The wireless communication terminal 200 may further include a processor 250 for controlling components other than those described above and a display unit 260 for displaying information such as setting values or the operating state of the wireless communication terminal 200.

Wireless communication security methods in the physical layer using the wireless communication system described above are described below.

### First Embodiment

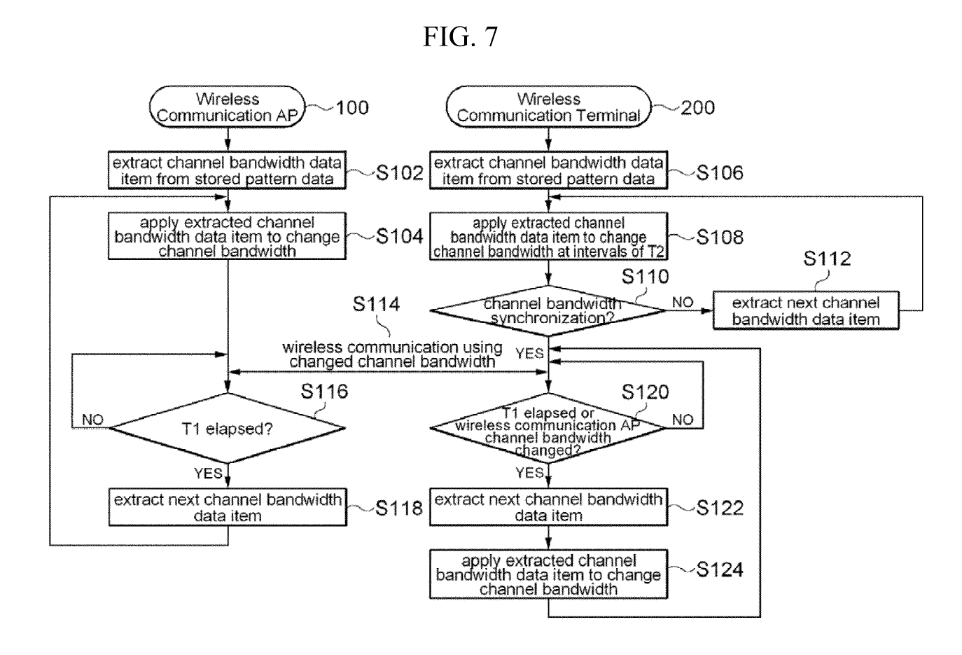

FIG. 7 is a flowchart illustrating a first embodiment of a physical layer security method in the wireless communication system of the present invention.

As shown in FIG. 7, in the physical layer security method according to the first embodiment, the wireless communication AP 100 and the wireless communication terminal 200 share the same channel bandwidth pattern data and a channel bandwidth is changed by sequentially acquiring a channel bandwidth data from the channel bandwidth pattern data at intervals of the channel bandwidth change period.

More specifically, the wireless communication AP 100 acquires a channel bandwidth data from stored channel bandwidth pattern data (S102) and performs PLL control based on the acquired channel bandwidth data to change the bandwidth of a communication channel (S104).

On the other hand, the wireless communication terminal 200 also acquires a channel bandwidth data from stored channel bandwidth pattern data (S106) and performs PLL control based on the acquired channel bandwidth data to change the bandwidth of a communication channel (S108). Here, channel bandwidth change may be performed at intervals of the channel bandwidth search period T2. Wireless communication between the wireless communication AP 100 and the wireless communication terminal 200 is not performed if the changed channel bandwidth is not identical to the channel bandwidth of the wireless communication AP 100 (S110). The wireless communication terminal 200 acquires a next channel bandwidth data from the channel bandwidth pattern data (S112) and applies the acquired channel bandwidth data to again change the channel bandwidth (S108). This procedure is repeated until a channel bandwidth identical to the channel bandwidth of the wireless communication AP 100 is found.

In such a channel bandwidth synchronization procedure (S102 to S112), the channel bandwidth search period T2 of the wireless communication terminal 200 may be set to an interval smaller than the channel bandwidth change period T1 of the wireless communication AP 100. Preferably, the channel bandwidth search period T2 may be set to be sufficiently small such that it is possible to apply all channel bandwidth data included in the channel bandwidth pattern data to change the channel bandwidth within the channel bandwidth change period T1.

Thereafter, when the channel bandwidth synchronization procedure is completed, the wireless communication AP 100 and the wireless communication terminal 200 may perform wireless communication using the changed channel bandwidth (S114).

Thereafter, when the channel bandwidth change period T1 has elapsed (S116), the wireless communication system 1000 acquires a next channel bandwidth data (S118) and applies the acquired channel bandwidth data to change the channel bandwidth (S104). This procedure (S104, S116, and S118) may be repeatedly performed.

Similarly, when the channel bandwidth change period T1 has elapsed or when wireless communication with the wireless communication AP 100 has been terminated due to change of the channel bandwidth in the wireless communication AP 100 (S120), the wireless communication terminal 200 acquires a next channel bandwidth data from the channel bandwidth pattern data (S122) and applies the acquired channel bandwidth data to change the channel bandwidth (S124).

In this case, since the wireless communication terminal 200 has already known the positions of the currently applied channel bandwidth data and the next channel bandwidth data to be applied in the channel bandwidth pattern data through the channel bandwidth synchronization procedure, the wireless communication terminal 200 can sequentially change the channel bandwidth without performing an additional channel bandwidth synchronization procedure.

### Second Embodiment

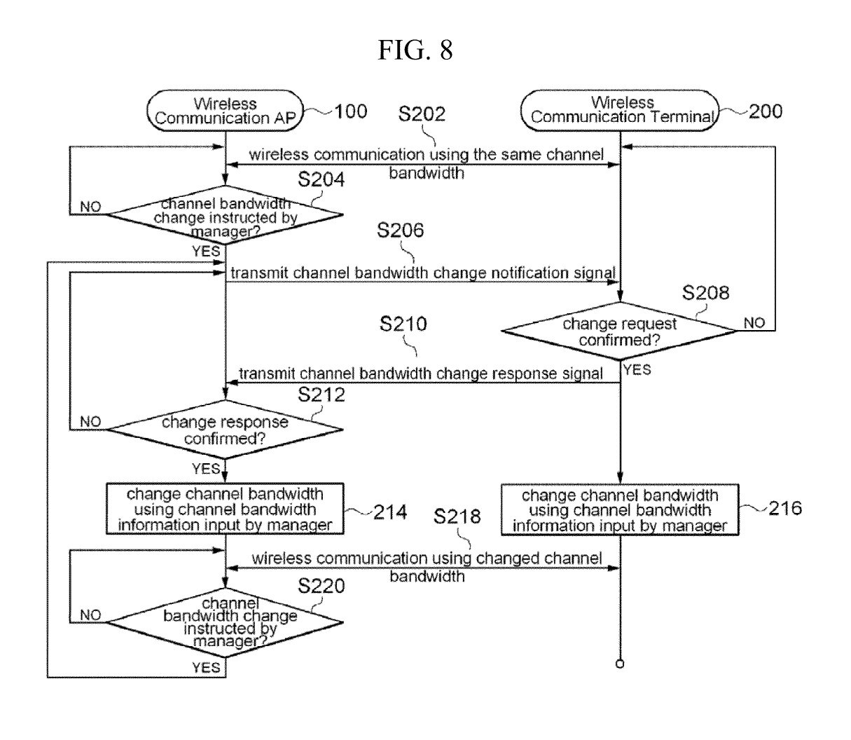

FIG. 8 is a flowchart illustrating a second embodiment of a physical layer security method in the wireless communication system of the present invention.

As shown in FIG. 8, in the physical layer security method according to the second embodiment, the wireless communication AP 100 and the wireless communication terminal 200 perform a channel bandwidth change procedure in response to a channel bandwidth change instruction from a user (or manager).

More specifically, while the wireless communication AP 100 and the wireless communication terminal 200 perform wireless communication using the same channel bandwidth (S202), the wireless communication AP 100 detects input of a channel bandwidth change signal from the user (S204). Here, the wireless communication AP 100 and the wireless communication terminal 200 may initially establish a connection with each other using a standard channel bandwidth or may synchronize their channel bandwidths through the channel bandwidth synchronization procedure of FIG. 7 described above.

Upon receiving the channel bandwidth change instruction, the wireless communication AP 100 transmits a channel bandwidth change notification signal to the wireless communication terminal 200 (S206). Then, the wireless communication terminal 200 checks suitability of the channel bandwidth change instruction (S208) and then transmits a channel bandwidth change response signal to the wireless communication AP 100 (S210).

Thereafter, the wireless communication AP 100 checks whether or not the received channel bandwidth change response signal is suitable (S212). When the received channel bandwidth change response signal is suitable, the wireless communication AP 100 changes the channel bandwidth using the channel bandwidth data input by the user (S214).

The wireless communication terminal 200 also changes the channel bandwidth using the channel bandwidth data input by the user after transmitting the channel bandwidth change response signal (S216).

Thereafter, the wireless communication AP 100 and the wireless communication terminal 200 perform wireless communication using the changed channel bandwidth (S218). Such wireless communication may be continued until a new channel bandwidth change instruction is input by the user (S220).

### Third Embodiment

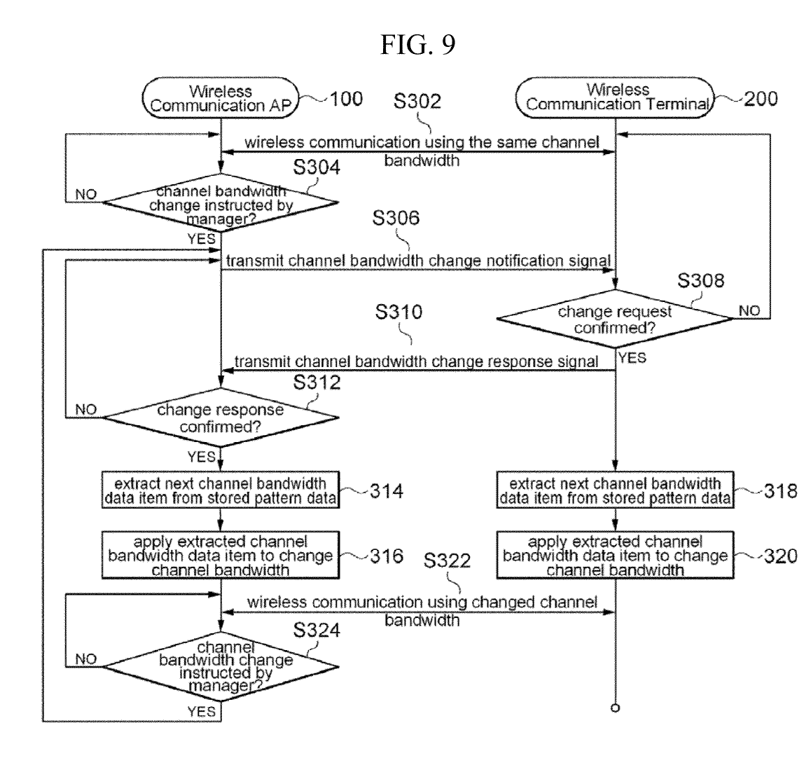

FIG. 9 is a flowchart illustrating a third embodiment of a physical layer security method in the wireless communication system of the present invention.

As shown in FIG. 9, the physical layer security method according to the third embodiment is similar to the physical layer security method according to the second embodiment. However, unlike the physical layer security method according to the second embodiment, in the procedure for changing the channel bandwidth after the channel bandwidth change notification signal and the channel bandwidth change response signal are transmitted and received, channel bandwidth data input by the user is not applied but instead a channel bandwidth data to be applied is acquired from the stored pattern data (S314 and S318) and the channel bandwidth is changed using the acquired channel bandwidth data (S316 and S320).

In this case, since the wireless communication AP 100 and the wireless communication terminal 200 have previously performed wireless communication using the same channel bandwidth, the wireless communication AP 100 and the wireless communication terminal 200 have already known the position of the next channel bandwidth data to be applied and therefore there is no need to perform an additional channel bandwidth synchronization procedure.

### Fourth Embodiment

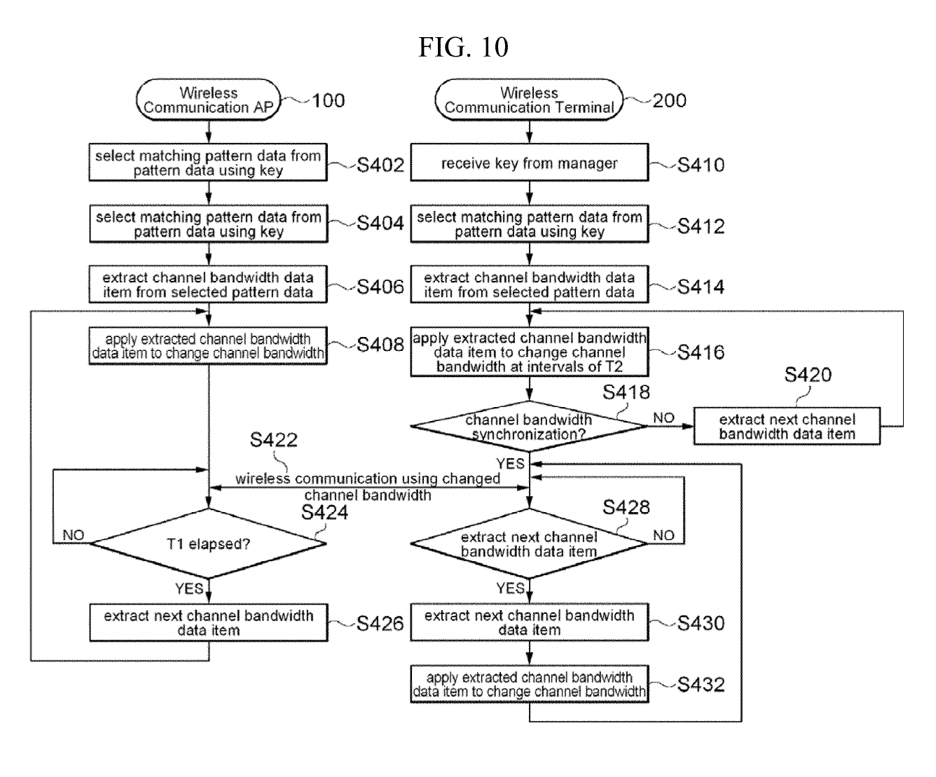

FIG. 10 is a flowchart illustrating a fourth embodiment of a physical layer security method in the wireless communication system of the present invention.

As shown in FIG. 10, the physical layer security method according to the fourth embodiment is similar to the physical layer security method according to the first embodiment. However, the fourth embodiment is characterized in that a pattern table including one or more channel bandwidth pattern data is further provided.

Specifically, each of the wireless communication AP 100 and the wireless communication terminal 200 receives a key value from the user (S402 and S410) and selects a matching (or corresponding) channel bandwidth pattern data from a pattern table stored in each of the wireless communication AP 100 and the wireless communication terminal 200 using the key value as an index (S404 and S412). Thereafter, each of the wireless communication AP 100 and the wireless communication terminal 200 acquires a channel bandwidth data from the selected channel bandwidth pattern data (S406 and S414) and changes the channel bandwidth using the acquired channel bandwidth data (S408 and S416). The subsequent processes (S418 to S432) are similar to the processes (S110 to S124) of the first embodiment and therefore a redundant description thereof is omitted herein.

### Fifth Embodiment

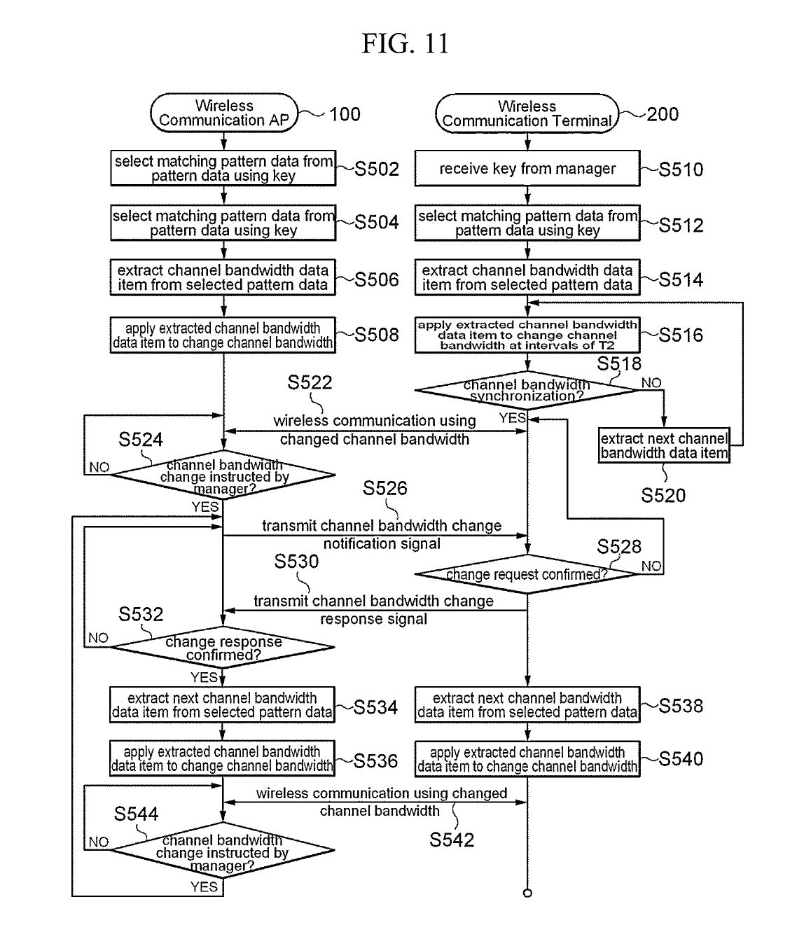

FIG. 11 is a flowchart illustrating a fifth embodiment of a physical layer security method in the wireless communication system of the present invention.

As shown in FIG. 11, the physical layer security method according to the fifth embodiment is similar to the physical layer security method according to the third embodiment. However, compared to the third embodiment, the fifth embodiment is characterized in that a pattern table including one or more channel bandwidth pattern data is further provided.

Specifically, each of the wireless communication AP 100 and the wireless communication terminal 200 receives a key value from the user (S502 and S510) and selects a matching (or corresponding) channel bandwidth pattern data from a pattern table stored in each of the wireless communication AP 100 and the wireless communication terminal 200 using the key value as an index (S504 and S512). Thereafter, each of the wireless communication AP 100 and the wireless communication terminal 200 acquires a channel bandwidth data from the selected channel bandwidth pattern data (S506 and S514) and changes the channel bandwidth using the acquired channel bandwidth data (S508 and S516). The subsequent processes (S518 to S532) are similar to the processes (S310 to S324) of the third embodiment and therefore a redundant description thereof is omitted herein.

According to the wireless communication system described above, the wireless communication AP and the wireless communication terminal perform communication with each other using a changed channel bandwidth and therefore there is an advantage in that it is possible to block access by a third party who does not share the changed channel bandwidth data.

### MODE FOR THE INVENTION

Various embodiments have been described in the best mode for carrying out the invention.

Although exemplary embodiments of the present invention have been described for illustrative purposes, those skilled in the art will appreciate that various modifications, additions and substitutions are possible without departing from essential characteristics of the invention.

Thus, the embodiments described herein are intended to be illustrative without limiting the technical spirit of the invention and should not be used to limit the scope of the invention.

The scope of the invention should be determined by reasonable interpretation of the appended claims and all changes coming within the equivalency range of the invention are intended to be embraced in the scope of the invention.

1. A wireless communication Access Point (AP) whose security has been enhanced in a physical layer, the wireless communication AP comprising:
a storage unit that manages channel bandwidth pattern data;
a controller for sequentially acquiring channel bandwidth data from the channel bandwidth pattern data;
a PLL controller for changing a channel bandwidth based on the acquired channel bandwidth data; and
a wireless interface unit for performing wireless communication with a wireless communication terminal using the changed channel bandwidth,
wherein the channel bandwidth pattern data is identical to channel bandwidth pattern data stored in the wireless communication terminal, and
the wireless communication terminal and the wireless communication AP are synchronized with each other such that the wireless communication terminal and the wireless communication AP perform wireless communication using the same channel bandwidth.

2. The wireless communication AP according to claim 1, wherein the channel bandwidth pattern data is a series of pattern data including one or more channel bandwidth data, each having a unique value or some values.

3. The wireless communication AP according to claim 1, wherein the channel bandwidth pattern data further includes a channel bandwidth change period data that corresponds to the channel bandwidth data.

4. The wireless communication AP according to claim 1, wherein the storage unit includes a pattern table in which a plurality of channel bandwidth pattern data is stored, and
the controller acquires channel bandwidth pattern data, which corresponds to a key value input by a user, from the pattern table based on the input key value.

5. The wireless communication AP according to claim 1, further comprising a user interface that receives at least one of channel bandwidth data or a channel bandwidth change instruction from a user,
wherein the controller changes the channel bandwidth based on the received channel bandwidth data in response to input of the channel bandwidth change instruction.

6. The wireless communication AP according to claim 1, wherein the controller transmits a channel bandwidth change notification signal to the wireless communication terminal through the wireless interface unit and changes the channel bandwidth upon receiving a channel bandwidth change response signal from the wireless communication terminal within a predetermined time in response to the channel bandwidth change notification signal.

7. A wireless communication terminal whose security has been enhanced in a physical layer, the wireless communication terminal comprising:
a storage unit that manages channel bandwidth pattern data;
a controller for sequentially acquiring channel bandwidth data from the channel bandwidth pattern data;
a PLL controller for changing a channel bandwidth based on the acquired channel bandwidth data; and
a wireless interface unit for performing wireless communication with a wireless communication Access Point (AP) using the changed channel bandwidth,
wherein the channel bandwidth pattern data is identical to channel bandwidth pattern data stored in the wireless communication AP, and
the wireless communication AP and the wireless communication terminal are synchronized with each other such that the wireless communication AP and the wireless communication terminal perform wireless communication using the same channel bandwidth.

8. The wireless communication terminal according to claim 7, wherein the channel bandwidth pattern data is a series of pattern data including one or more channel bandwidth data, each having a unique value or some values.

9. The wireless communication terminal according to claim 7, wherein the channel bandwidth pattern data further includes a channel bandwidth change period T1 that corresponds to the value of channel bandwidth data.

10. The wireless communication terminal according to claim 9, wherein the PLL controller receives channel bandwidth data from the controller and changes channel bandwidths at intervals of a channel bandwidth search period T2, and
the controller determines whether or not a channel bandwidth of the wireless communication AP is identical to any of the channel bandwidths changed at intervals of the channel bandwidth search period T2 and achieves synchronization with a changed channel bandwidth identical to the channel bandwidth of the wireless communication AP.

11. The wireless communication terminal according to claim 10, wherein the channel bandwidth search period T2 is set to be smaller than the channel bandwidth change period T1.

12. The wireless communication terminal according to claim 7, wherein the storage unit includes a pattern table in which a plurality of channel bandwidth pattern data is stored, and
the controller acquires channel bandwidth pattern data, which corresponds to a key value input by a user, from the pattern table based on the input key value.

13. The wireless communication terminal according to claim 7, wherein the controller transmits a channel bandwidth change response signal to the wireless communication AP within a predetermined time in response to a channel bandwidth change notification signal received from the wireless communication AP.

14. A wireless communication system whose security has been enhanced in a physical layer, the wireless communication system comprising:
a wireless communication Access Point (AP) that sequentially changes channel bandwidths according to predefined channel bandwidth pattern data; and
a wireless communication terminal that sequentially changes channel bandwidths according to channel bandwidth pattern data identical to the channel bandwidth pattern data of the wireless communication AP and performs wireless communication with the wireless communication AP,
wherein the wireless communication AP and the wireless communication terminal change channel bandwidths based on the channel bandwidth pattern data through PLL control, and
the wireless communication AP and the wireless communication terminal are synchronized with each other such that the wireless communication AP and the wireless communication terminal perform wireless communication using the same channel bandwidth.

15. The wireless communication system according to claim 14, wherein the channel bandwidth pattern data is a series of pattern data including one or more channel bandwidth data, each having a unique value or some values.

16. The wireless communication system according to claim 15, wherein the channel bandwidth pattern data further includes a channel bandwidth change period T1 that corresponds to the value of channel bandwidth data.

17. The wireless communication system according to claim 16, wherein the wireless communication AP sequentially changes channel bandwidths at intervals of the channel bandwidth change period T1, and
the wireless communication terminal sequentially changes channel bandwidths based on the channel bandwidth pattern data at intervals of a channel bandwidth search period T2, searches for a channel bandwidth that matches a channel bandwidth of the wireless communication AP, and changes a channel bandwidth of the wireless communication terminal to the matching channel bandwidth.

18. The wireless communication system according to claim 17, wherein the channel bandwidth search period T2 is set to be smaller than the channel bandwidth change period T1.

19. The wireless communication system according to claim 14, wherein each of the wireless communication AP and the wireless communication terminal manages a pattern table in which a plurality of channel bandwidth pattern data is stored, and
the wireless communication AP or the wireless communication terminal acquires channel bandwidth pattern data that corresponds to a key value input by a user based on the input key value.

20. The wireless communication system according to claim 14, wherein the wireless communication AP transmits a channel bandwidth change notification signal to the wireless communication terminal,
the wireless communication terminal transmits a channel bandwidth change response signal to the wireless communication AP within a predetermined time in response to the channel bandwidth change notification signal, and
the wireless communication AP changes a channel bandwidth of the wireless communication AP upon receiving the channel bandwidth change response signal from the wireless communication terminal within a predetermined time.

21-30. (canceled)
